(19) United States
(12) Patent Application Publication
(10) Pub. No.: US 2007/0168274 A1
(43) Pub. Date: Jul. 19, 2007

(54) System and method for financial management of advance earned income credit

(76) Inventor: Robert H. Taylor, Jacksonville, FL (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/331,745

(22) Filed: Jan. 13, 2006

(51) Int. Cl. G06Q 40/00

(52) U.S. Cl. 705/36 T

(57) ABSTRACT

A system and method for financial management of advance earned income credit, wherein eligible taxpayers may elect direct deposit of their paychecks (i.e., net pay), advance earned income credit (advance EIC) inclusive, onto a stored-value debit card that functions as a main bank account. Thereafter, the advance EIC portion of the taxpayer's net pay may be automatically extracted from the net pay direct deposited onto the debit card and conveniently transferred into an associated sub-account (also referred to as a savings pocket or purse). Through the present debit card and associated sub-account program, and the accumulated advance EIC payments thereof, taxpayers may qualify to receive various benefits, including, without limitation, interest accumulation on sub-account balances, credit card issuance with overdraft protection, loan eligibility, and credit history development.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to financial data processing and management, and more specifically to a system and method for financial management of advance earned income credit, wherein the present invention provides, amongst other features, a stored-value debit card and an associated sub-account program.

### BACKGROUND OF THE INVENTION

Earned income credit is a refundable federal tax credit or benefit available to certain low-income individuals who have earned income, meet adjusted gross income thresholds, and do not have more than a certain amount of disqualified income (i.e., capital gain net income, net passive income, interest, dividends, tax-exempt interest, and non-business rents or royalties). Assuming a taxpayer's eligibility, the total amount of refundable credit is largely dependant upon the taxpayer's claimed marital status and number of qualifying children. Additionally, scheduled phase-out percentages (i.e., reduction of total refunded credit) are instituted depending upon the taxpayer's claimed marital status and number of qualifying children.

Notably, the earned income credit is refundable to the extent that it reduces the tax liability below zero. Accordingly, an eligible taxpayer may elect to receive advance payment of the credit through his or her paychecks. Currently, in making such an election, eligible employees (i.e., taxpayers) utilize IRS Tax Form W-5 in order to notify their employer that they choose to receive advance payments (i.e., advance earned income credit), instead of waiting until they file their annual tax returns. The amount of the earned income credit that may be received as an advance payment is similarly dependent upon the number of claimed qualifying children. In all instances, however, the actual advance credit to which a taxpayer is entitled is treated as payment, and is included in the taxpayer's paychecks.

Although earned income credit and advance earned income credit programs function to reduce the overall tax burden and, thus, largely mitigate the financial distresses of lower-income individuals and families, such federal aid programs present notable disadvantages (i.e., inconvenient and time-consuming check cashing procedures) and, more importantly, are deficient or ineffective in resolving the underlying issue of poor fiscal management systemic amongst a likely measurable populace of financially-uneducated low-income earners. Indeed, such financial aid programs, absent an associated method of promoting financial management and responsibility, may even have the tendency of encouraging financially-imprudent behavior.

More specifically, such credit programs do not provide a financial vehicle or sub-program that might otherwise incentivize or motivate eligible taxpayers to save and accumulate the tax credit payments for purposes of developing or promoting long-term financial stability. Instead, such programs simply pay out or refund tax credits to any eligible individuals, whom, without the requisite motivation or guidance, may simply view such payments as immediate disposable income; thereby, lending to continued fiscal irresponsibility and mismanagement (i.e., undesirable spending habits, living “check-to-check”, etc.). Additionally, individuals who do not possess a bank account, are often forced to cash their paychecks, including those containing the earned income credit, with check-cashing facilities; thereby, exposing these individuals to the inconveniences and costs associated with such transactions.

Indeed, those most affected by the absence of such a financial management program, are the financially-conscious populace of lower income earners, who look to the earned income credit and advance earned income credit programs as much needed financial aid, but, despite a willingness to develop long-term financial stability, are not provided with the requisite means for accomplishing same.

Accordingly, the inability to develop and maintain a long-term financial asset, adversely affects the taxpayer's ability to develop and/or receive a line of credit with a banking institution, business, or the like. Consequently, many low-income earners are unable, or otherwise hindered in their ability, to make large purchases requiring an established credit history and the concordant assumption of a loan, such as during the purchase of a first home or vehicle. Unfortunately, the collective long-term effect is a marked stagnation in standard of living of affected low-income earners and, thus, an overall decline in motivation or ambition in the pursuit of financial stability.

Therefore, it is readily apparent that there is a need for a system and method for financial management of advance earned income credit, wherein the present invention provides low-income taxpayers with an advance earned income credit direct deposit and sub-account savings program that, through associated credit-building programs, accumulated interest programs, and loan programs, motivates or encourages fiscal responsibility.

### BRIEF SUMMARY OF THE INVENTION

Briefly described, in a preferred embodiment, the present invention overcomes the above-mentioned disadvantage, and meets the recognized need for such an invention by providing a system and method for financial management of advance earned income credit, wherein eligible taxpayers may elect direct deposit of their paychecks (i.e., net pay), advance earned income credit (advance EIC) inclusive, onto a stored-value debit card that functions as a main bank account. Thereafter, the advance EIC portion of the taxpayer's net pay may be automatically extracted from the net pay direct deposited onto the debit card and conveniently transferred into an associated sub-account (also referred to as a savings pocket or purse). Through the present debit card and associated sub-account program, and the accumulated advance EIC payments thereof, taxpayers may qualify to receive various benefits, including, without limitation, interest accumulation on sub-account balances, credit card issuance with overdraft protection, and loan eligibility.

According to its major aspects and broadly stated, the present invention in its preferred form is a system and method for financial management of advance earned income credit, generally comprising a program application and eligibility process, debit card and sub-account issuance process, advance EIC request process, net pay transfer/deposit process, advance EIC extraction process, and advance EIC transfer process. The foregoing processes are preferably implemented through a globally-networked computer system and associated application software; thereby, preferably automating the present system and method. Additional features and components of the present invention include, without limitation, a credit-building program, accumulated interest programs, and loan programs.

More specifically, the present invention is a system and method for financial management of advance earned income credit, wherein a globally-networked computer system and associated application software enable qualified or eligible taxpayers, or their authorized representative(s), to access a web portal and request or apply therethrough for direct deposit of their net pay, advance EIC inclusive, onto a stored-value debit card (i.e., main bank account) and, thereafter, for automated extraction of their available advance EIC directly from the net pay contained on the debit card for transfer into an associated sub-account.

That is, an application software, preferably provided by a card program sponsor of the present system, enables an eligible taxpayer (or tax preparer) to enter applicable personal and tax-related data (i.e., marital status, number of qualifying children, etc.) through a designated web portal and, thus, request therethrough debit card and sub-account program setup, and associated automated extraction of their available advance EIC. Following such data entry, the taxpayer's data is preferably concurrently transmitted to, and processed by the card program processor, and a card program bank sponsor. In turn, the card program processor and/or program bank sponsor coordinate in issuing a debit card (i.e., main bank account) to the taxpayer, and establishing the associated sub-account.

Thereafter, applicable IRS tax forms requesting advance EIC are forwarded to the taxpayer's employer, who may then calculate and transmit, via automated clearing house (ACH), the taxpayer's net pay, advance EIC inclusive, to the taxpayer's debit card (i.e., main bank account), preferably operated by card program bank sponsor. Following the foregoing transmission, the bank sponsor preferably reports receipt of the taxpayer's net pay amount to the card program processor, whereupon the card program processor, via the web portal, similarly reports receipt of the taxpayer's net pay amount to the taxpayer.

Furthermore, upon receipt of the taxpayer's net pay amount from the bank sponsor, the card program processor utilizes the application software of the web portal to reference the taxpayer's previously entered personal and tax-related data and, thereby, tabulate total value of available advance EIC for extraction from the taxpayer's net pay contained on the debit card. Final values are reported to the card program processor and program bank sponsor.

Thereafter, the tabulated value of advance EIC is automatically extracted from the taxpayer's debit card and transferred into the associated sub-account, wherein the taxpayer may then avail himself, if applicable, to various benefits arising from the accumulation, development and maintenance of a preferred threshold balance of advance EIC within the sub-account program of the present invention.

In particular, the foregoing referenced benefits include, without limitation, the ability to convert the stored value debit card into a secured credit card with overdraft protection of up to a fixed percentage of the balance accumulated within the sub-account; the ability to earn interest on the balance accumulated within the sub-account; the ability to utilize the balance accumulated within the sub-account as collateral on low-interest rate short-term loans; the ability to transfer accumulated sub-account balances to the main bank account and gain access to an otherwise unavailable source of funds for cash flow emergencies; and, the ability to develop or establish a credit history with a banking institution, business, or the like, and, thus receive a line of credit therefrom.

Accordingly, a feature and advantage of the present invention is its ability to provide low-income taxpayers with an advance earned income credit direct deposit and sub-account savings program that, through associated credit-building programs, accumulated interest programs, and loan programs, motivates or encourages fiscal responsibility.

Another feature and advantage of the present invention is its ability to provide a globally-networked computer system and associated application software for facilitating the automated extraction of advance earned income credit from a taxpayer's net pay.

Still another feature and advantage of the present invention is its ability to facilitate the accumulation of advance earned income credit payments in a sub-account that functions in association with a stored value debit card (or main bank account).

Yet another feature and advantage of the present invention is its ability to provide an application software that accounts for a taxpayer's earned income, adjusted gross income, disqualified income, number of claimed qualifying children, marital status, and the like, in tabulating the taxpayer's available advance earned income credit.

Still yet another feature and advantage of the present invention is its ability to automate, via computer systems and application software, an otherwise manual application and reporting process.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a process flow diagram of a system and method for financial management of advance earned income credit, according to a preferred embodiment of the present invention;

FIG. 2A is an earned income credit lookup table utilized in the advance EIC calculation sub-process of a system and method for financial management of advance earned income credit, according to a preferred embodiment of the present invention;

FIG. 2B is a state lookup table utilized in the advance EIC calculation sub-process of a system and method for financial management of advance earned income credit, according to a preferred embodiment of the present invention;

FIG. 2C is an EIC code table utilized in the advance EIC calculation sub-process of a system and method for financial management of advance earned income credit, according to a preferred embodiment of the present invention;

FIG. 2D is a pay frequency code table utilized in the advance EIC calculation sub-process of a system and method for financial management of advance earned income credit, according to a preferred embodiment of the present invention;

FIG. 2E is an iteration of a dynamic wage table utilized in the advance EIC calculation sub-process of a system and method for financial management of advance earned income credit, according to a preferred embodiment of the present invention;

FIG. 2F is an iteration of a dynamic wage table utilized in the advance EIC calculation sub-process of a system and method for financial management of advance earned income credit, according to a preferred embodiment of the present invention;

FIG. 3 is an example of a graphical user provided by the application software of a system and method for financial management of advance earned income credit, according to a preferred embodiment of the present invention;

FIG. 4 is an example of a graphical user provided by the application software of a system and method for financial management of advance earned income credit, according to a preferred embodiment of the present invention;

FIG. 5 is an example of a graphical user provided by the application software of a system and method for financial management of advance earned income credit, according to a preferred embodiment of the present invention;

FIG. 6 is an example of a graphical user provided by the application software of a system and method for financial management of advance earned income credit, according to a preferred embodiment of the present invention;

FIG. 7 is an example of a graphical user provided by the application software of a system and method for financial management of advance earned income credit, according to a preferred embodiment of the present invention;

FIG. 8 is an example of a graphical user provided by the application software of a system and method for financial management of advance earned income credit, according to a preferred embodiment of the present invention;

FIG. 9 is an example of a graphical user provided by the application software of a system and method for financial management of advance earned income credit, according to a preferred embodiment of the present invention;

FIG. 10 is an example of a graphical user provided by the application software of a system and method for financial management of advance earned income credit, according to a preferred embodiment of the present invention;

FIG. 11 is an example of a graphical user provided by the application software of a system and method for financial management of advance earned income credit, according to a preferred embodiment of the present invention;

FIG. 12 is an example of a graphical user provided by the application software of a system and method for financial management of advance earned income credit, according to a preferred embodiment of the present invention;

FIG. 13 is an example of a graphical user provided by the application software of a system and method for financial management of advance earned income credit, according to a preferred embodiment of the present invention;

FIG. 14 is an example of a graphical user provided by the application software of a system and method for financial management of advance earned income credit, according to a preferred embodiment of the present invention;

FIG. 15 is an example of a graphical user provided by the application software of a system and method for financial management of advance earned income credit, according to a preferred embodiment of the present invention;

FIG. 16 is an example of a graphical user provided by the application software of a system and method for financial management of advance earned income credit, according to a preferred embodiment of the present invention;

FIG. 17 is an example of a graphical user provided by the application software of a system and method for financial management of advance earned income credit, according to a preferred embodiment of the present invention;

FIG. 18 is an example of a graphical user provided by the application software of a system and method for financial management of advance earned income credit, according to a preferred embodiment of the present invention; and,

FIG. 19 is an example of a graphical user provided by the application software of a system and method for financial management of advance earned income credit, according to a preferred embodiment of the present invention.

### DETAILED DESCRIPTION OF THE PREFERRED AND ALTERNATIVE EMBODIMENTS

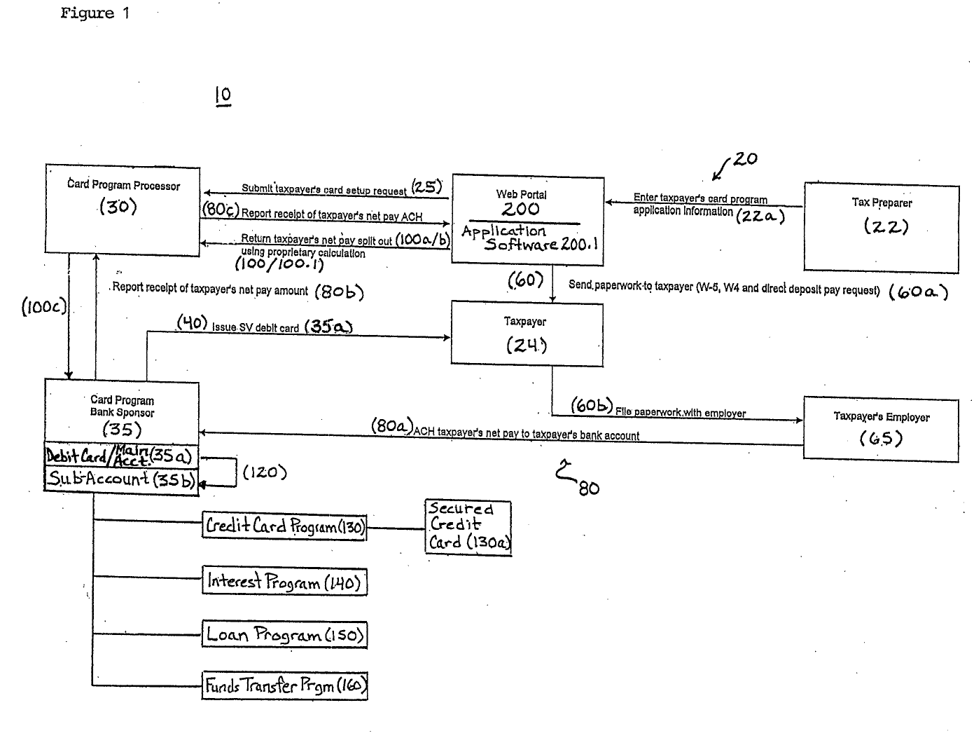

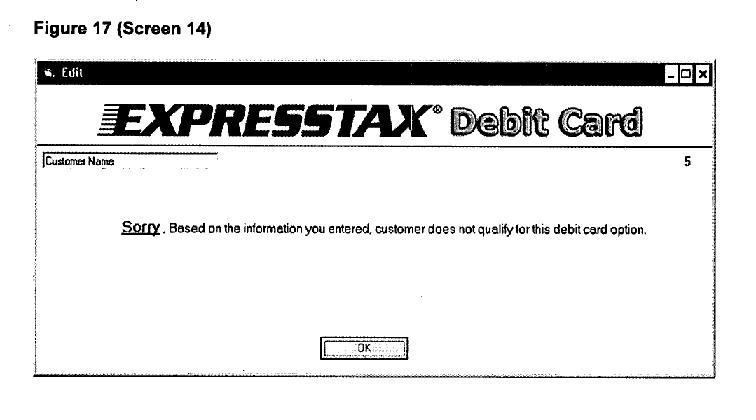

In describing the preferred and alternate embodiments of the present invention, as illustrated in FIGS. 1-19, specific terminology is employed for the sake of clarity. The invention, however, is not intended to be limited to the specific terminology so selected, and it is to be understood that each specific element includes all technical equivalents that operate in a similar manner to accomplish similar functions.

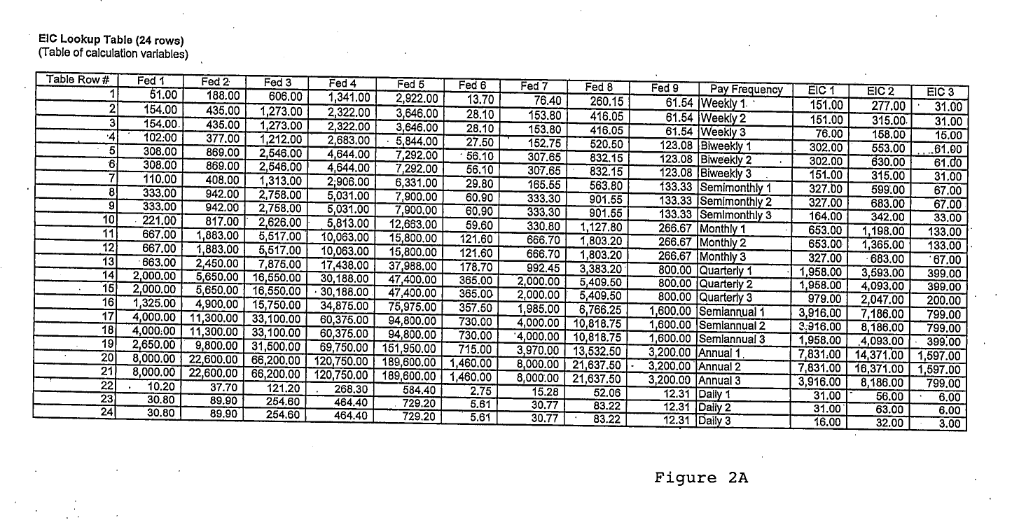

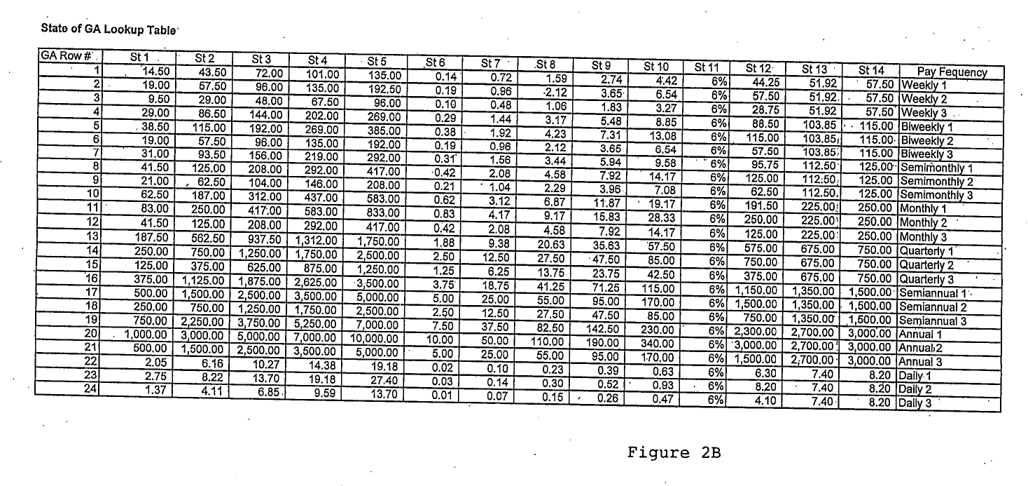

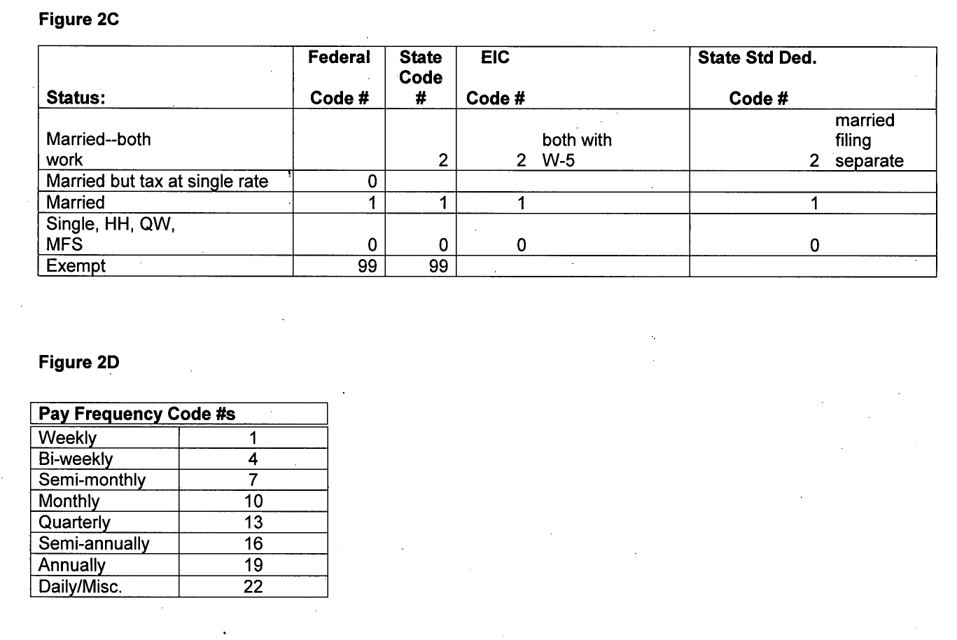

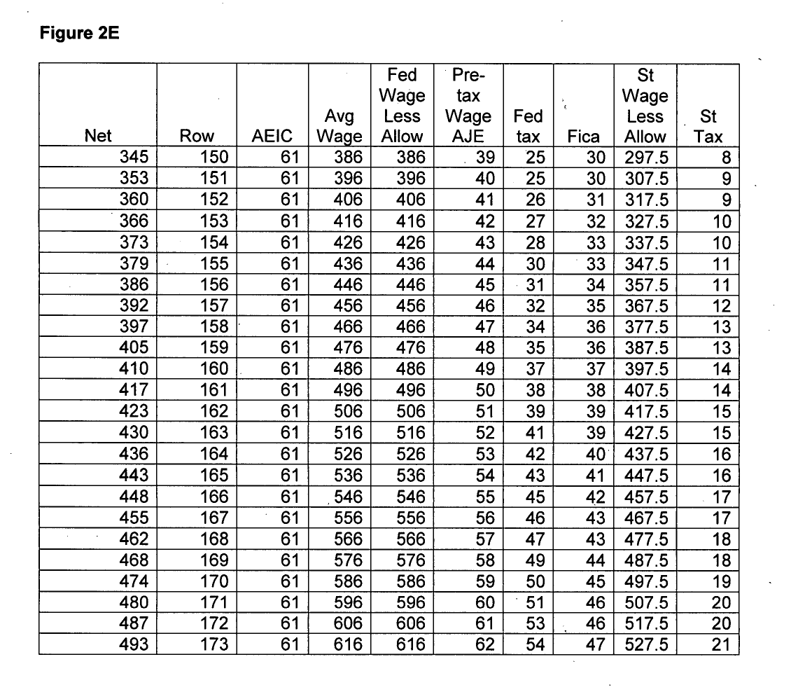

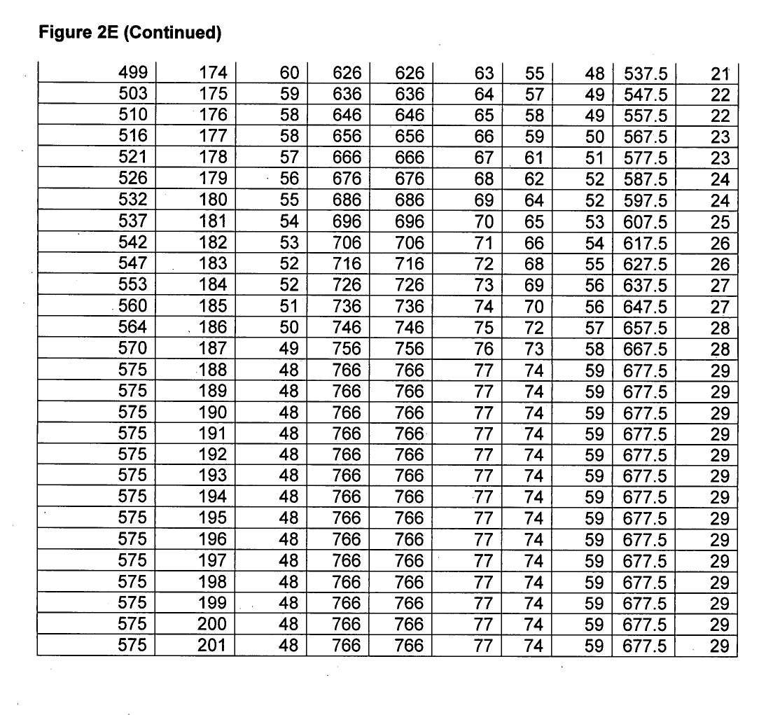

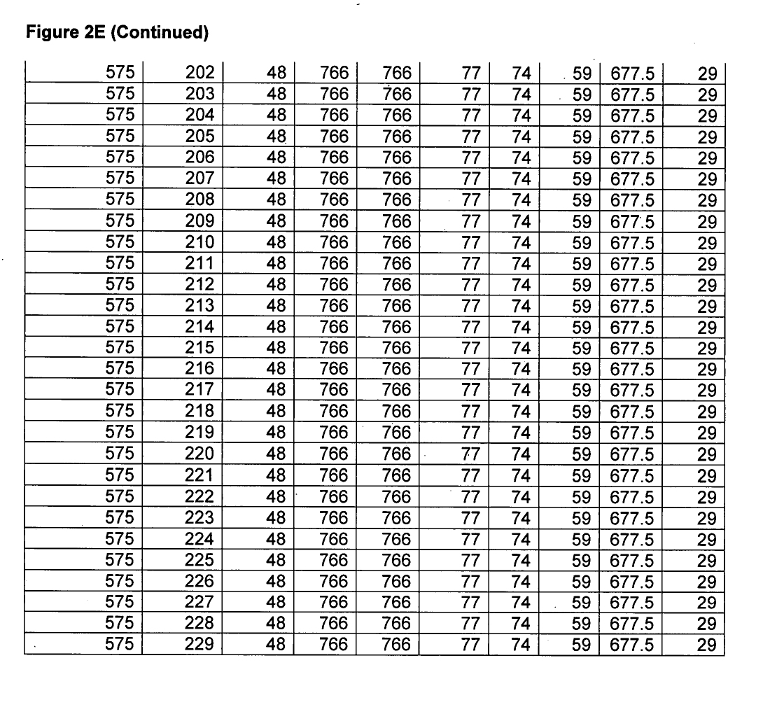

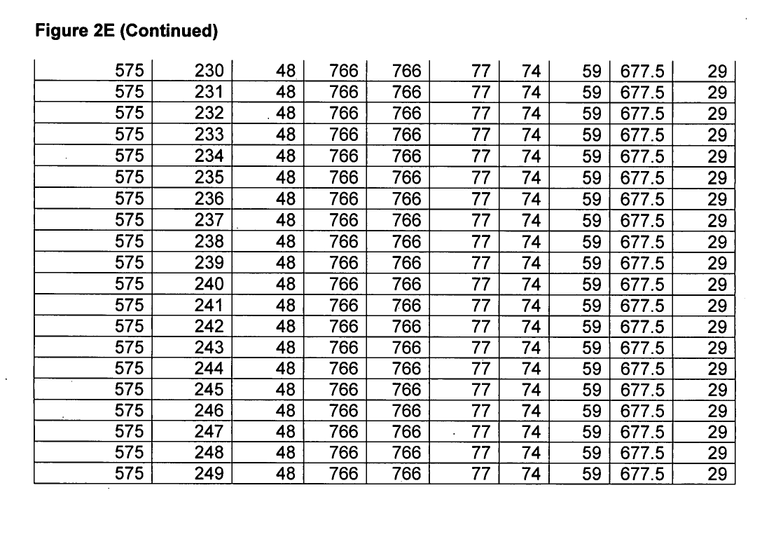

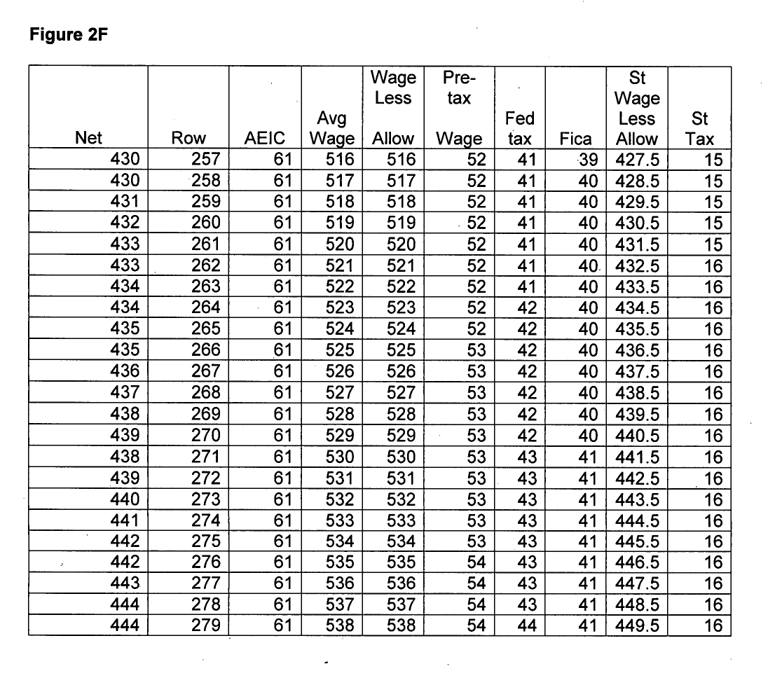

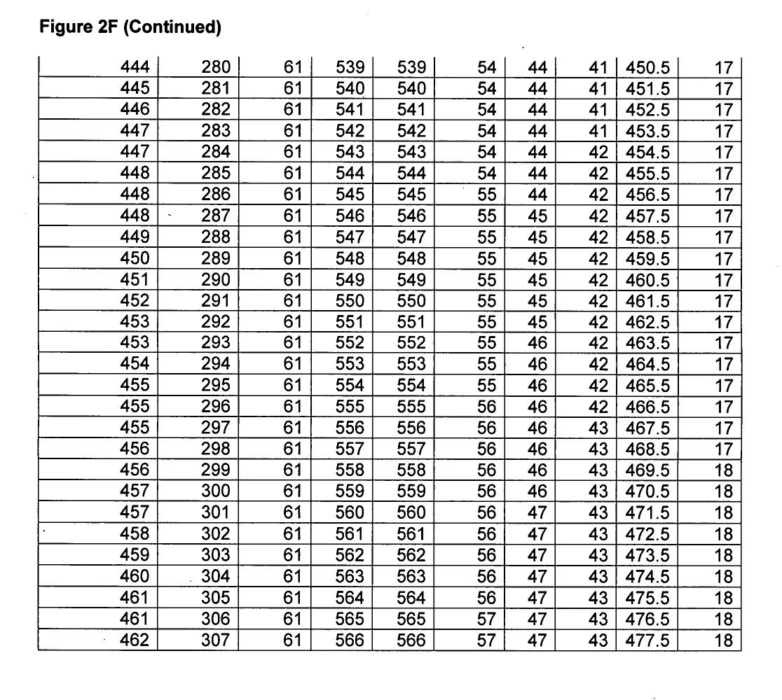

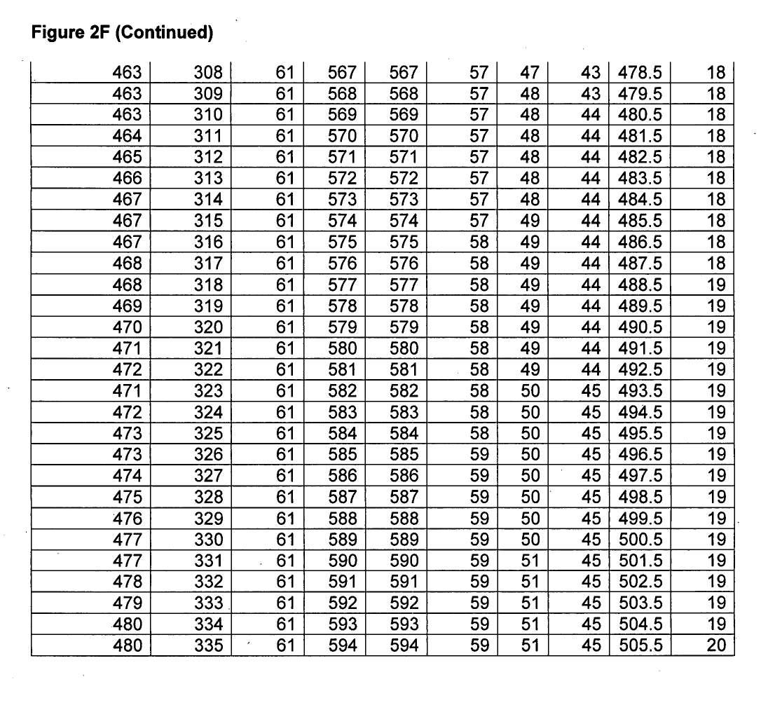

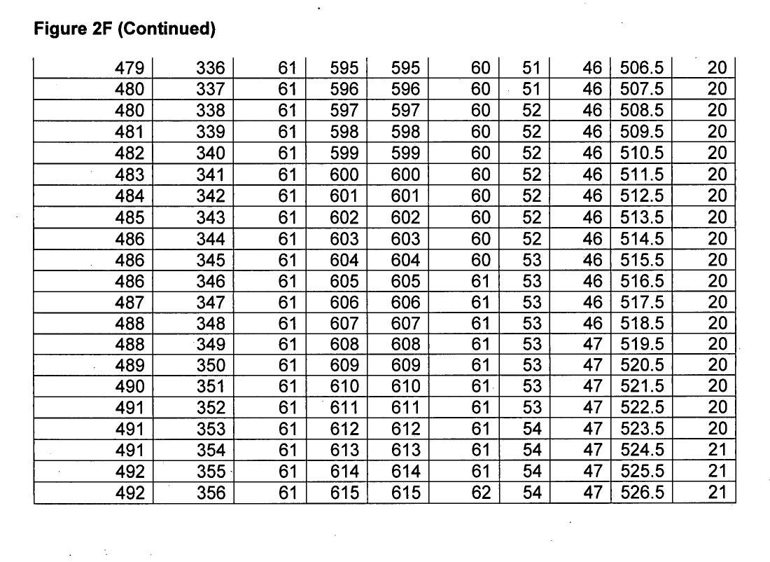

Referring now to FIG. 1, the present invention in its preferred embodiment is a system and method 10 for financial management of advance earned income credit, comprising a program application and eligibility step 20, debit card and sub-account issuance step 40, advance EIC request step 60, net pay transfer step 80, advance EIC extraction step 100, and advance EIC transfer step 120. As more fully described hereinbelow, and with reference to FIGS. 2A-2F, advance EIC extraction step 100 preferably comprises advance EIC calculation sub-process 100.1. As also more fully described hereinbelow, the foregoing steps of system and method 10 are largely implemented via a globally-networked computer system and web portal 200, and associated application software 200.1; thereby, automating system and method 10, and, thus, an otherwise manual advance EIC application and reporting process.

Referring now more specifically to FIG. 1, program application and eligibility step 20 entails tax preparer 22 utilizing web portal 200 on a globally-networked computer system to access application software 200.1, wherein tax preparer 22 preferably enters (22a) therethrough taxpayer's (24) personal and tax-related information, as queried and required by application software 200.1, for application and verification of eligibility of taxpayer 24 into the present system 10. That is, eligibility step 20, via application software 200.1, is utilized to determine whether taxpayer 24 legally qualifies to receive advance EIC and, thus, taxpayer's (24) eligibility to partake in the advance EIC automated extraction process 100 of the present invention, and the associated stored-value debit card and sub-account program steps 40 and 120, for managing accumulated advance EIC.

Preferably following data entry via the foregoing eligibility step 20, a debit card/sub-account program setup request step 25 based on and comprising taxpayer's (24) data is preferably concurrently transmitted to, and processed by card program processor 30, and card program bank sponsor 35. Upon processing taxpayer's (24) personal and tax-related data, and the associated card and account setup request, debit card and sub-account issuance step 40 is preferably implemented, wherein card program processor 30 and/or program bank sponsor 35 coordinate in issuing stored value debit card 35a (a (prepaid) personalized or non-personalized debit card) to taxpayer 24, and establishing the associated sub-account 35b through program bank sponsor 35. As noted hereinabove, debit card 35a functions as taxpayer's (24) main bank account and, as such, the terms debit card 35a and main bank account 35a shall be synonymously and interchangeably utilized herein in describing the present invention. Accordingly, and as more fully described hereinbelow, taxpayer's (24) net pay, advance EIC inclusive, is preferably directly deposited onto debit card 35a (main bank account 35a), wherein taxpayer's (24) available advance EIC is preferably automatically extracted from the net pay of debit card 35a and, thereafter, transferred into associated sub-account 35b.

Following card/account issuance step 40, or in concordance therewith, advance EIC request step 60 is preferably initiated, wherein applicable IRS tax forms and consent forms (i.e., IRS Form W-5, IRS Form W-4, direct deposit pay request forms, and the like) for requesting advance EIC payments are forwarded (60a), via web portal 200, to taxpayer 24, who may then transmit or otherwise provide (60b) same to his employer 65. It should be recognized that such applicable IRS tax forms could alternatively be directly transmitted, via web portal 200, to employer 65 at the pre-election or consent of taxpayer 24 during implementation of eligibility step 20.

Upon employer's (65) receipt of taxpayer's (24) advance EIC request 60 and associated tax forms, net pay transfer step 80 is preferably initiated, wherein employer 65 preferably calculates and transmits (80a), via automated clearing house (ACH), taxpayer's (24) net pay (advance EIC included) to taxpayer's (24) debit card 35a. Following net pay transfer step 80, 80a, bank sponsor 35 preferably reports (80b) receipt of taxpayer's (24) net pay amount to card program processor 30, whereupon card program processor 30, via web portal 200, similarly reports (80c) receipt of taxpayer's (24) net pay amount to taxpayer 24.

Although advance EIC calculation process 100.1 is more fully described hereinbelow, advance EIC extraction step 100 generally comprises implementation of calculation process 100.1, via application software 200.1 and associated web portal 200, to calculate the total amount of requested advance EIC that may be split-out or extracted from taxpayer's (24) net pay direct deposited onto debit card 35a. In implementing advance EIC extraction step 100, and tabulating total value of available advance EIC via associated calculation process 100.1, card program processor 30 utilizes application software 200.1 of web portal 200 to reference taxpayer's (24) previously entered personal and tax-related data and, thereby, tabulate total value of available advance EIC for extraction or separation (100a) from taxpayer's (24) net pay. All final values or results of net pay and extracted advance EIC are preferably reported (100b, 100c) to card program processor 30 and program bank sponsor 35.

Following reporting steps 100b, 100c, advance EIC transfer step 120 is preferably implemented, wherein the tabulated amount of advance EIC is preferably extracted from taxpayer's (24) net pay direct deposited onto debit card 35a and, thereafter, transferred (120) into taxpayer's (24) sub-account 35b for accessibility via taxpayer's debit card 35a, and the benefits described hereinbelow. Of course, the remaining net pay on debit card 35a (i.e., within main bank account 35a) may further be accessed and utilized by taxpayer 24.

Notably, taxpayer 24 may avail himself to various benefits arising from the accumulation, development and maintenance of a preferred threshold balance of advance EIC within his sub-account program 35b of the present invention. Specifically, via credit card program 130, taxpayer 24 may elect to convert stored value debit card 35a into a secured credit card 130a with overdraft protection of up to a fixed percentage of the balance accumulated within sub-account 35b. Additionally, via interest program 140, taxpayer 24 may be eligible to earn interest on a certain threshold balance of accumulated advance EIC within sub-account 35b, wherein the threshold balance is preferably selected by card program bank sponsor 35.

Similarly, via loan program 150, taxpayer 24 may be eligible to utilize the balance of advance EIC accumulated within sub-account 35b as collateral on low-interest rate short-term loans offered by card program bank sponsor 35. Additionally, through general accumulation of advance EIC funds within sub-account 35b, taxpayer 24 is able to develop or establish a credit history with a banking institution, business, or the like, and, thus receive a line of credit therefrom. Furthermore, via funds transfer program 160, taxpayer 24 may transfer accumulated sub-account 35b advance EIC balances to main account 35a and gain access to an otherwise unavailable source of funds for cash flow emergencies, wherein the amount of transferable advance EIC may be governed or otherwise restricted by program bank sponsor 35 depending upon taxpayer's (24) involvement with credit card program 130, interest program 140 and/or loan program 160.

Referring now more specifically to FIGS. 2A-2F, advance EIC calculation sub-process 100.1, of advance EIC extraction process 100, is preferably utilized to facilitate the accurate tabulation and extraction of taxpayer's (24) available advance EIC from his net pay direct deposited onto debit card 35a. Advance EIC calculation sub-process 100.1 may be best understood with combined reference to the steps delineated in the process table produced hereinbelow, and FIGS. 2A-2F. Additionally, Example Calculation 1, presented hereinbelow, demonstrates application of the process steps of sub-process 100.1. (Note: the dynamic wage tables of FIGS. 2E, 2F are based upon the hypothetical data presented in Example Calculation 1, and application of sub-process 100.1 steps thereto. As such, it should be recognized that various iterations of the dynamic wage tables of FIGS. 2E, 2F may be provided based upon variances of data, and the application of sub-process 100.1 steps thereto.)

Advance EIC Calculation Sub-Process 100.1:

As referred to hereinbelow, the EIC Code number and Pay Frequency Code number yielded from the EIC Code table of FIG. 2C and the Pay Frequency Code table of FIG. 2D, respectively, are derived by application software 200 with reference to taxpayer's (24) inputs for filing status, pay frequency, and the like, of application and eligibility step 20. As such, the tables of FIGS. 2C, 2D reflect how application software 200 translates these inputs/data into codes that can be summed together to provide a row reference in the tables of FIGS. 2A, 2B, both of which contain values utilized in process 100 for calculating federal and state withholding tax and advance EIC.

| Steps | Description of Steps |
|---|---|
| 100.1a | Select the appropriate EIC Lookup Table Row Number |
| | (see FIG. 2A, twenty-four sequentially numbered |
| | rows in EIC Lookup Table). If applicable, select |
| | the appropriate state Lookup Table Row Number (see |
| | FIG. 2B, twenty-four sequentially numbered rows |
| | within Georgia (GA) state-based Lookup Table). |
| | Row selection within the EIC Lookup Table of FIG. |
| | 2A (and Lookup Table of FIG. 2B, if applicable) is |
| | preferably based on the sum of the EIC Code number |
| | and Pay Frequency Code number derived by |
| | application software 200 utilizing an EIC Code |
| | table (see FIG. 2C) and a Pay Frequency Code table |
| | (see FIG. 2D). |
| | The data/results of the selected row(s) from the |
| | applicable Lookup Table(s) of FIGS. 2A, 2B are |
| | preferably utilized to populate calculation |
| | variables germane to final calculation of available |
| | advance EIC. |
| 100.1b | Gross up the net pay amount received by card |
| | processor (30) from taxpayer's (24) employer (65) |
| | (see net pay transfer step 80, 80a of FIG. 1 |
| | hereinabove), and calculate wage increment for a |
| | dynamically built wage table (see Step 100.1c |
| | hereinbelow). |
| 100.1c | Dynamically build a wage table (see Dynamic Wage |
| | Table of FIG. 2E) reflecting the following |
| | calculation results for each wage increment in the |
| | table: |
| | Wage table row number |
| | Advance EIC (based on taxpayer status, pay |
| | frequency, and pre-tax deductions) |
| | Standard federal tax (based on the number of |
| | federal withholding allowances, taxpayer |
| | status, pay frequency, and pre-tax deductions) |
| | Federal Insurance Contributions Act (FICA) |
| | Standard state tax (based on the number of |
| | state withholding allowances, taxpayer state |
| | status, and pre-tax withholdings, if |
| | applicable) |
| | Net pay (based on the foregoing calculations |
| | results) |
| 100.1d | Refer to FIG. 2E and perform wage table lookup to |
| | find row with closest matching net pay to the |
| | amount received by card processor (30). |
| | Note: The net pay amount reported by card processor |
| | (30) must be adjusted for post-tax deductions and |
| | additional federal/state withholdings prior to wage |
| | table lookup. |
| 100.1e | Lookup corresponding average wage, and decrease |
| | wage increment by a multiple of ten. |
| | Repeat Steps 100.1c through 100.1e of building |
| | various iterations of dynamic wage tables (see FIG. |
| | 2F for another iteration of a Dynamic Wage Table), |
| | performing wage table lookups, and decreasing wage |
| | increment by a multiple of ten until the increment |
| | drops to zero. |
| 100.1f | Lookup final advance EIC amount and report results |
| | back to card processor (30). |

### EXAMPLE CALCULATION 1

With continued reference to FIGS. 2A-2F, application of steps 100.1a-f of sub-process 100.1 for calculation of available advance EIC may be demonstrated as follows:

Total net pay, advance EIC inclusive, is preferably calculated by employer 65, based on taxpayer's (24) personal and tax-related information, and thereafter transmitted to card processor 30 via net pay transfer step 80, 80a (see FIG. 1). Accordingly, based on the hypothetical data presented hereinbelow, employer 65 may calculate net pay of taxpayer 24 as follows:

Hypothetical Data:

| Filing Status | Single |
|---|---|
| Pay Frequency | Bi-Weekly |
| # of Federal Allowances | 0 |
| Hourly Rate | 7 |
| Hours Worked | 80 |
| Gross Pay | $560.00 |
| Additional Federal Withholding Tax | $5.00 |
| Pre-Tax Deduction % | 10% |
| Pre-Tax Deduction Amount | |
| Post-Tax Deductions Amount | |
| State for Withholding Tax Purposes | GA |
| # of State Personal Allowances | 0 |
| # of State Additional Personal | 0 |
| Allowances | |
| # of State Dependent Allowances | 0 |
| Additional State Withholding Tax | $5.00 |

Based on the foregoing data, the following calculation may be made:

| | |
|---|---|
| Gross Pay | $560 |
| Pre-Tax Deductions | $56 |
| FICA | $42.84 |
| Taxable Pay | $504 |
| Federal Tax | $52 |
| Post-Tax Deductions | $0 |
| State Tax | $23 |
| Eligible Advance EIC | $504 |
| Income | |
| Advance EIC | $61 |
| Net Pay | $447.16 |

Following card processor's (30) receipt of the net pay amount, advance EIC calculation sub-process 100.1 begins with initiation of Step 100.1a, wherein reference is drawn to the EIC and state Lookup Tables of FIGS. 2A and 2B, respectively, and the applicable table row(s) selected upon summation of EIC Code number and Pay Frequency Code number of FIGS. 2C and FIG. 2D, respectively. Specifically, application software 200 sets the EIC code variable to 0 based on single filing status (see FIG. 2C), and sets Pay code variable to 4 based on Bi-Weekly pay frequency (see FIG. 2D). Process 100 retrieves these codes and other input variables from a linked database of application software 200, wherein the database can provide a complete list of process 100 inputs upon request. As such, based on the hypothetical data presented hereinabove, the code number sum equates to four (4), which is the row number utilized for both the EIC and state Lookup Tables of FIGS. 2A and 2B. Accordingly, the lookup results of row “4” of both the EIC and state Lookup Tables are preferably utilized to populate and provide the following calculation variables:

Calculation Variables from EIC Lookup Table Row #4

| | |
|---|---|
| Fed 1 | 102 |
| Fed 2 | 377 |
| Fed 3 | 1212 |
| Fed 4 | 2683 |
| Fed 5 | 5844 |
| Fed 6 | 27.50 |
| Fed 7 | 152.75 |
| Fed 8 | 520.50 |
| Fed 9 | 123.08 |
| EIC 1 | 302 |
| EIC 2 | 553 |
| EIC 3 | 61 |

Calculation Variables from state Lookup Table Row #4

| | |
|---|---|
| St 1 | 29.00 |
| St 2 | 86.50 |
| St 3 | 144.00 |
| St 4 | 202.00 |
| St 4 | 269.00 |
| St 6 | 0.29 |
| St 7 | 1.44 |
| St 8 | 3.17 |
| St 9 | 5.48 |
| St 10 | 8.85 |
| St 11a | 0.01 |
| St 11b | 0.02 |
| St 11c | 0.03 |
| St 11d | 0.04 |
| St 11e | 0.05 |
| St 11f | 0.06 |
| St 12 | 88.50 |
| St 13 | 103.85 |
| St 14 | 115.00 |
| St 15 | 0 |

Thereafter, Step 100.1b is preformed, wherein gross up net pay calculations are provided as follows:

| | |
|---|---|
| $447.16 | Net |
| 6.000% | State gross up % |
| $396.16 | Net less maximum EIC, plus additional federal |
| | and state withholding, plus post tax |
| | deductions |
| $678.9 | Gross up adjusted net for maximum federal and |
| | state tax and FICA (28% maximum federal rate) |
| $754.38 | Gross up for pre-tax |
| $51.94 | Adjustment for FICA |
| $760.62 | Gross up for FICA |
| $313.46 | Range |
| 10 | Increment |

Following Step 100.1b, the dynamic wage table of FIG. 2E is built via Step 100.1c, wherein Step 100.1d is thereafter initiated for purposes of performing a wage table lookup to find the row on the dynamic wage table of FIG. 2E having the closest matching net pay to the amount received by card processor (30). As stated hereinabove, the net pay amount reported by card processor (30) is preferably adjusted for post-tax deductions and additional federal/state withholdings prior to wage table lookup. Accordingly, in the present example, the following calculation is preferably made prior to wage table lookup:

| | |
|---|---|
| Net | $447.16 |
| Post tax | $0 |
| Additional federal withholding | $5 |
| Additional state withholding | $5 |
| Adjusted Net | $457 |

As such, the adjusted net amount of “457” is preferably utilized to locate the closest matching net pay on the dynamic wage table of FIG. 2E, which, in the present example, correlates with net amount “462” on the dynamic wage table of FIG. 2E. In locating the closest matching net amount exceeding the adjusted net of $457, the following information (also applicable to Step 100.1e hereinbelow) may be extracted from the table of FIG. 2E:

| | |
|---|---|
| AEIC Row | 168 |
| Average Wage | 566 |
| Increment | 1 |
| Adjustment | 50 |
| Minimum | 516 |
| Maximum | 616 |
| Advance EIC | 61 |

Upon lookup of the corresponding average wage of “566”, and decreasing the wage increment “1” by a multiple of ten (i.e., Step 100.1e), Steps 100.1c through 100.1e are preferably repeated to build various iterations of dynamic wage tables, perform wage table lookups, and decrease wage increments by a multiple of ten until the increment drops to zero; thereby, providing the total advance EIC amount for reporting to card processor 30 (i.e., Step 100.1f). Accordingly, in the present example, another iteration of a dynamic wage table is provided with reference to FIG. 2F, wherein the following information may be extracted from same:

| | |
|---|---|
| Adjusted Net | 457 |
| AEIC Row | 301 |
| Average Wage | 560 |
| Increment | 0 |
| Adjustment | 0 |
| Minimum | 560 |
| Maximum | 560 |
| Advance EIC | 61 |

Referring now more specifically to a further component of the present invention, application software 200.1 of web portal 200 preferably substantially automates system and method 10 and, thereby, automates an otherwise manual advance EIC application and reporting process. Specifically, application software 200.1 preferably guides and assists tax preparer 22 in establishing automated extraction of taxpayer's (24) available advance EIC from taxpayer's (24) net pay, and further assists tax preparer 22 in establishing associated stored-value debit card 35a and sub-account (or savings pocket) 35b, as described hereinabove. Accordingly, via specific sub-processes described more fully hereinbelow, application software 200.1 facilitates the various process steps of system and method 10, including application and eligibility step 20, debit card/sub-account issuance step 40, advance EIC request step 60, advance EIC extraction step 100, and advance EIC transfer step 120.

Application software 200.1 may be best understood with reference to the following primary components: application and account set-up sub-process 200.1a; card option editing sub-process 200.1b; and, advance EIC eligibility sub-process 200.1c, wherein sub-process 200.1c is preferably an associated process of, and otherwise integrated within, sub-processes 200.1a and 200.1b, as more fully described hereinbelow. Preferably, tax preparer 22 is provided access to each sub-process 200.1a-c via associated or dedicated screens (i.e., graphical user interfaces) of web portal 200, wherein tax preparer 22 is directed or prompted to enter requested data into each such screen associated with each sub-process 200.1a-c (applicable screens are described hereinbelow with reference to associated figures). Accordingly, the following provides a non-limiting example of the format and procedure of each such screen that tax preparer 22 may encounter in utilizing and navigating through each sub-process 200.1a-c of application software 200.1.

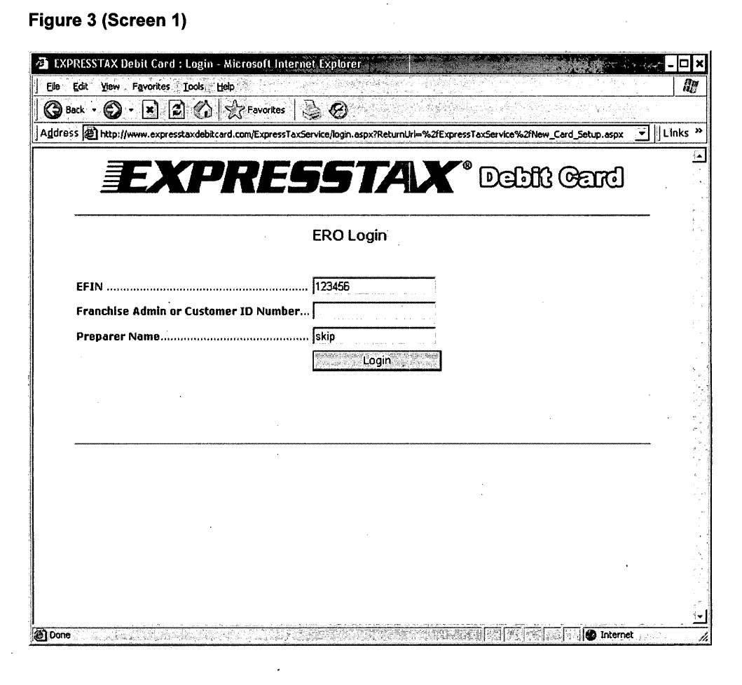

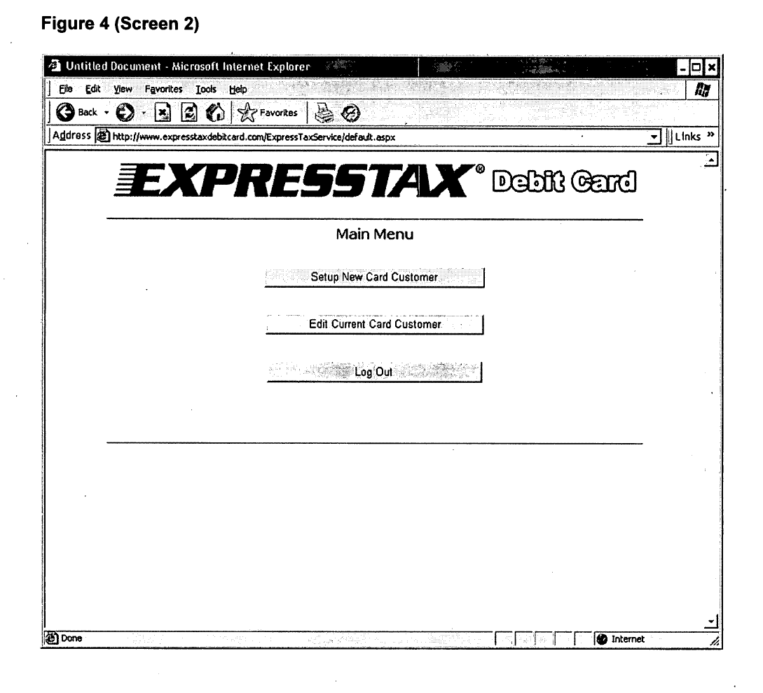

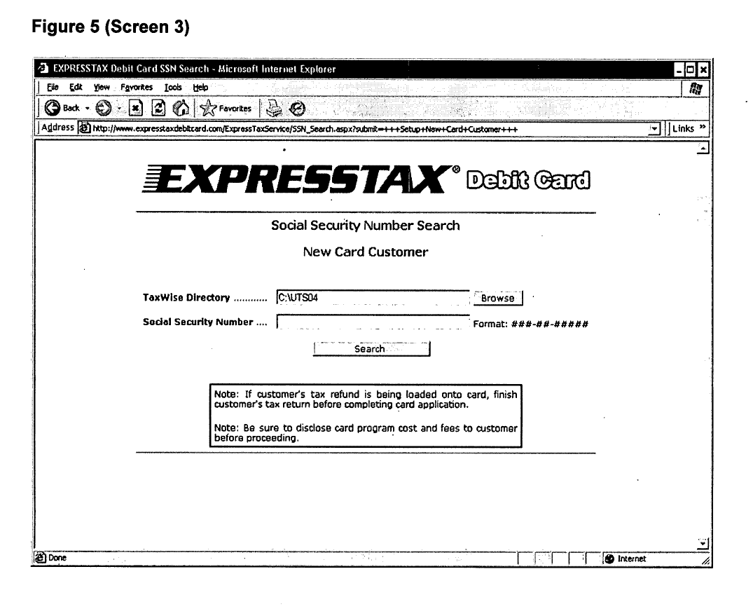

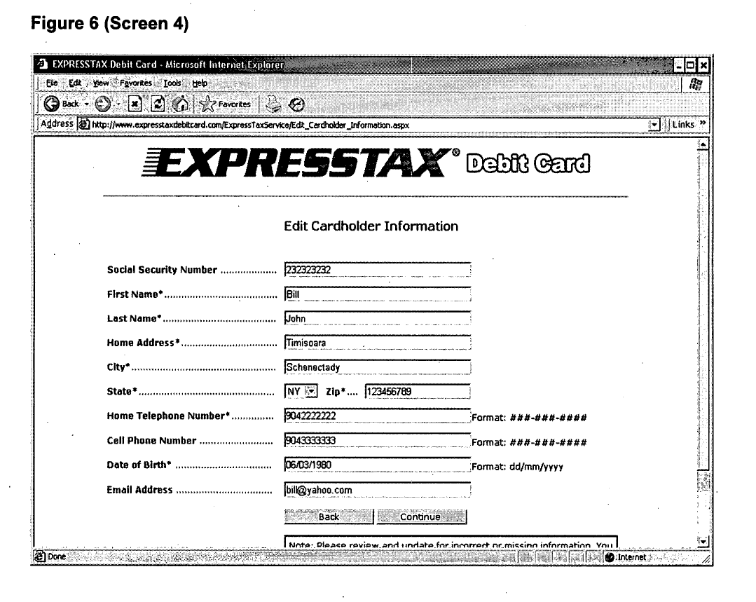

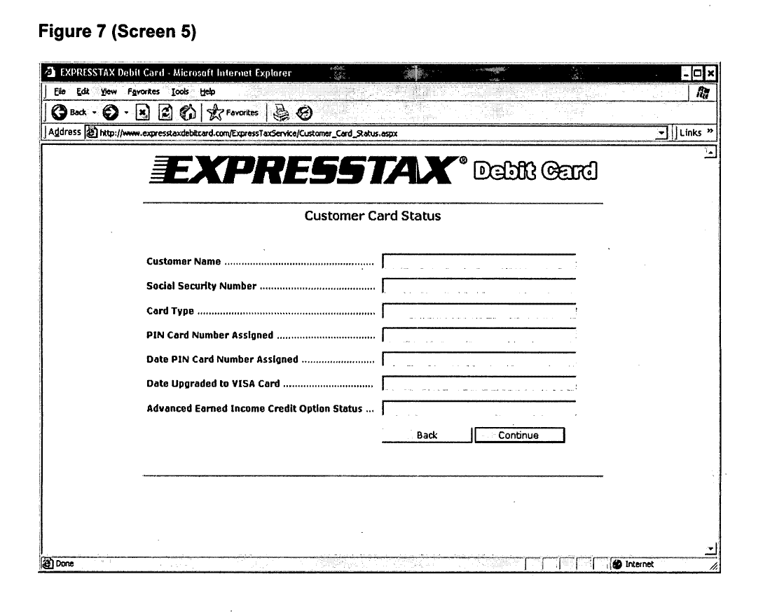

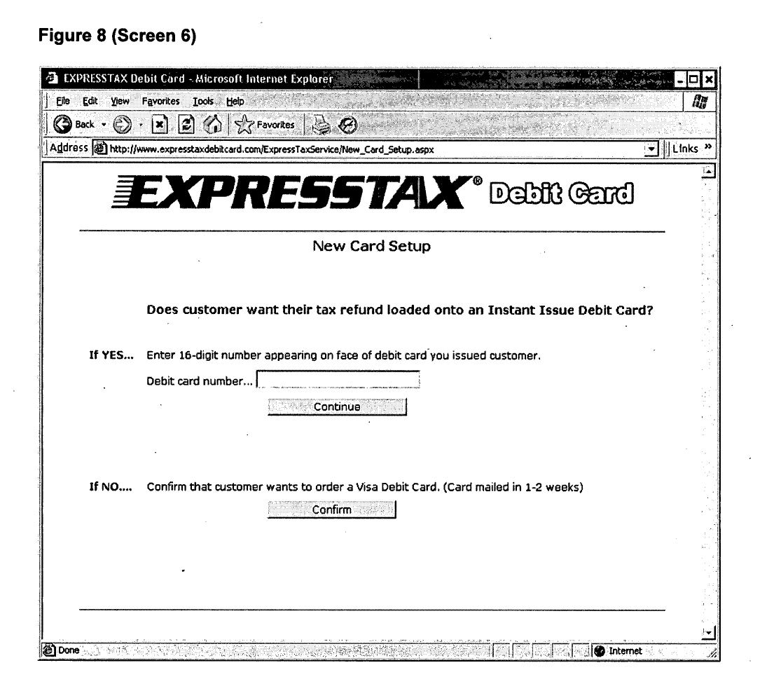

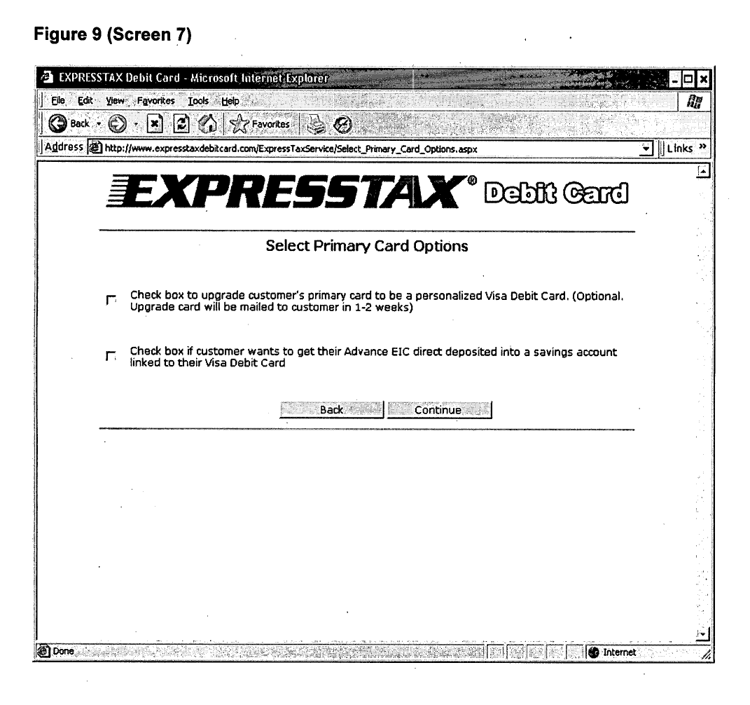

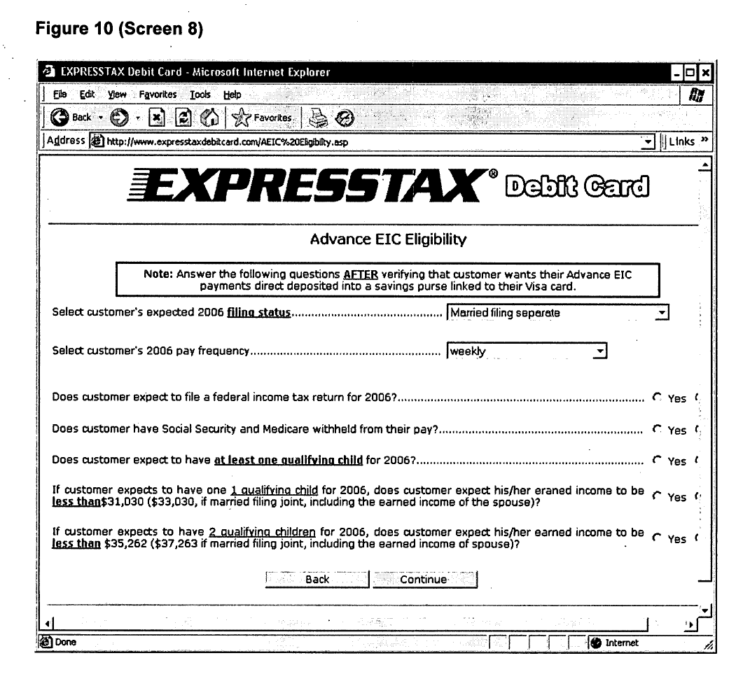

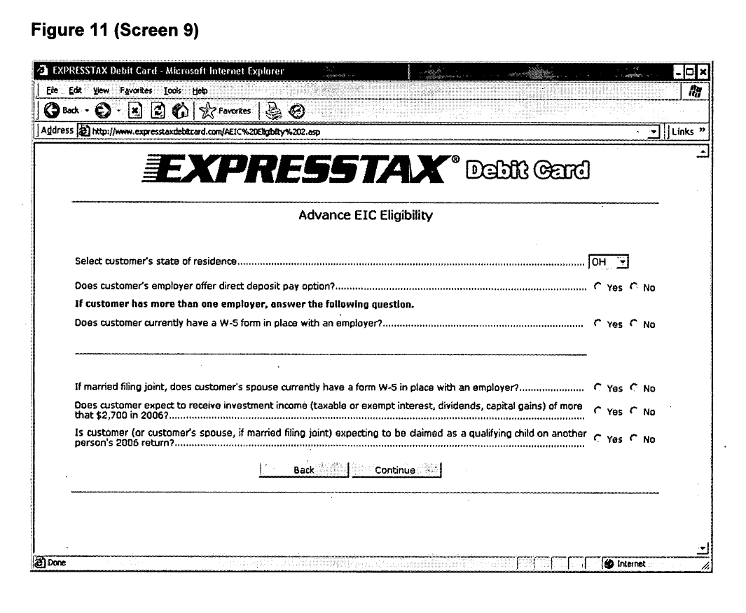

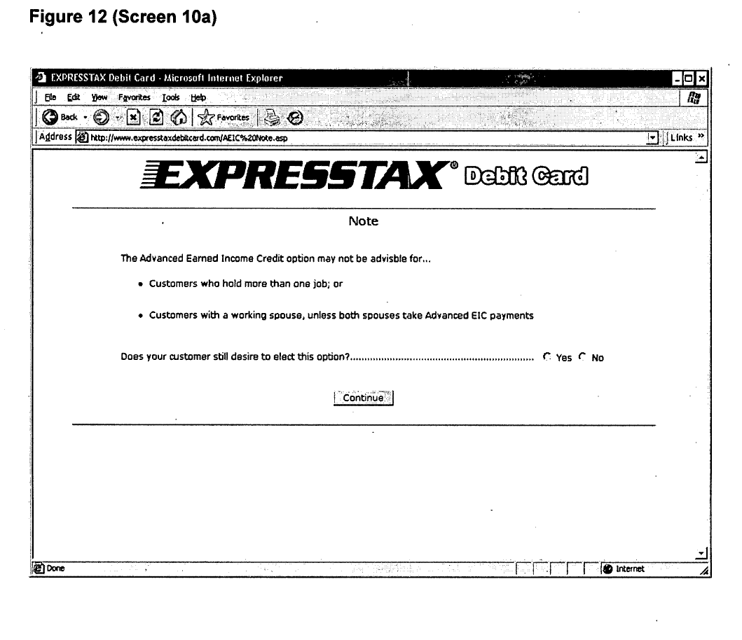

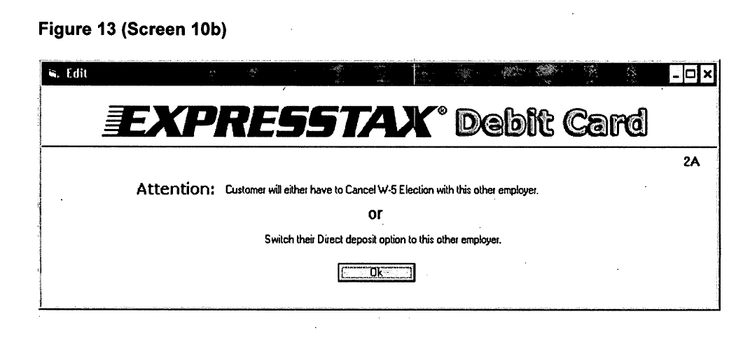

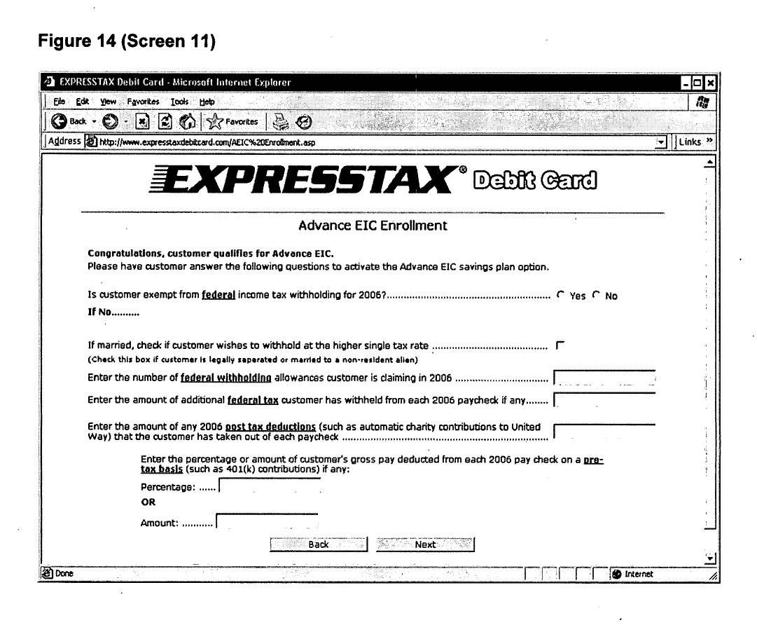

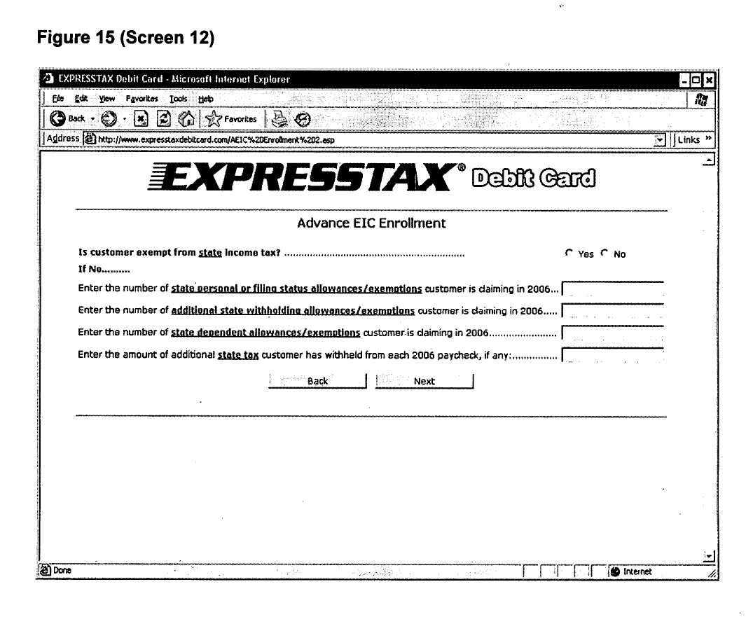

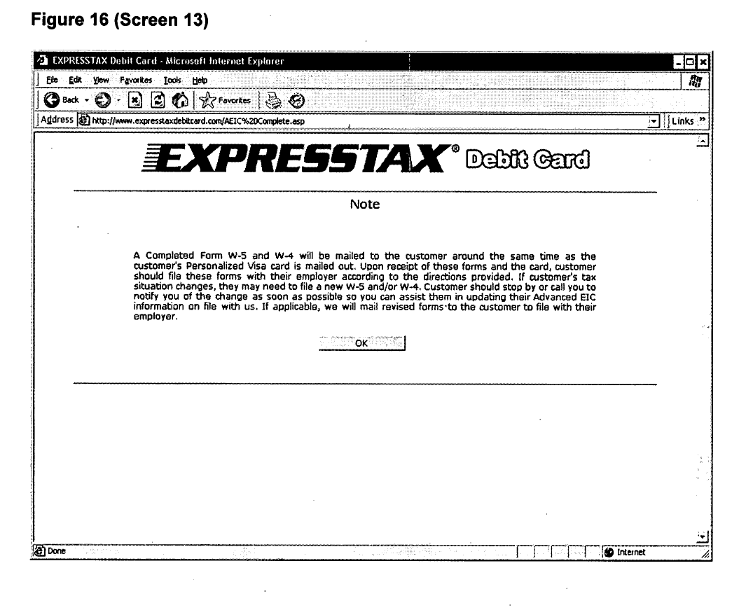

Application and Account Set-Up Sub-Process 200.1a:

| Steps | Data Entry Result/Result |
|---|---|
| 200.1a1 | Enter tax preparer's (22) identifying information, |
| | including Electronic Filing Identification Number |
| | (EFIN), name, and login password. See FIG. 3, |
| | Screen 1. |
| | Proceed to Main Menu screen (Step 200.1a2). |
| 200.1a2 | Select Main Menu option to “Setup New Card |
| | Customer”. See FIG. 4, Screen 2. |
| 200.1a3 | Enter taxpayer's (24) Social Security Number (SSN). |
| | See FIG. 5, Screen 3. |
| 200.1a4 | Perform tiered search for taxpayer's (24) SSN in |
| | available linked databases (i.e., database of |
| | existing cardholders and database of tax clients). |
| | See FIG. 5, Screen 3. |
| 200.1a5 | If match found in database of existing cardholders, |
| | then proceed to Step 200.1a7. Otherwise, if match |
| | found in database of tax clients, then proceed to |
| | Step 200.1a6. See FIG. 5, Screen 3. |
| | If no match found in either database, proceed to |
| | Step 200.1a8. |
| 200.1a6 | If Step 200.1a5 verifies a match found in database |
| | of tax clients, display taxpayer's contact |
| | information (i.e., name, address, telephone number, |
| | date of birth, etc.) as pulled from tax client |
| | database. See FIG. 6, Screen 4. |
| | Proceed to Step 200.1a10. |
| 200.1a7 | If Step 200.1a5 verifies a match found in database |
| | of existing cardholders, display Customer's Current |
| | Card Status Information (i.e., card number, date |
| | issued, etc.). See FIG. 7, Screen 5. |
| | Proceed to Step 200.1b7 of card option editing sub- |
| | process 200.1b hereinbelow. |
| 200.1a8 | If Step 200.1a5 verifies no match found in either |
| | linked database, display input screen for initial |
| | entry of cardholder contact information (i.e., name, |
| | address, telephone number, date of birth, etc.), |
| | wherein Screen 4 of FIG. 6 will appear blank for |
| | such data entry. |
| | Proceed to Step 200.1a9. |
| 200.1a9 | Enter new cardholder account contact information in |
| | Screen 4. |
| 200.1a10 | Select type of card 35a for initial issue (non- |
| | personalized instant issue PIN debit or personalized |
| | debit card (mailed to customer). If PIN debit card |
| | selected, enter PIN debit account number from face |
| | of card. See FIG. 8, Screen 6. |
| | Note: PIN debit card must be issued if cardholder |
| | wishes to have his current tax refund immediately |
| | loaded onto card. If personalized debit card |
| | selected, system will automatically assign virtual |
| | PIN debit number to the cardholder. |
| 200.1a11 | Select additional card setup options such as |
| | upgrading from non-personalized debit card to |
| | personalized debit card, and electing automatic |
| | split-out of advance EIC deposits into separate sub- |
| | account savings purse 35b associated with card 35a. |
| | See FIG. 9, Screen 7; see also advance EIC option |
| | (i.e., second check box) of Screen 7. |
| 200.1a12 | If advance EIC option (i.e., second check box) of |
| | Screen 7 is selected, proceed to Step 200.1a13. |
| | Otherwise, proceed to Step 200.1a15. |
| 200.1a13 | Provide responses to questions regarding advance EIC |
| | eligibility requirements as set forth in IRS |
| | regulations. The questions verify that cardholder |
| | is able to utilize the card program's advance EIC |
| | option based on current program criteria (ex., state |
| | of residence for state withholding purposes, and |
| | verification that cardholder's employer offers the |
| | direct deposit pay option. See FIGS. 10 and 11, |
| | Screens 8 and 9, respectively. |
| | Note: If cardholder's employer does not offer direct |
| | deposit pay, cardholder is ineligible to participate |
| | in program. |
| | If cardholder has more than one employer or |
| | cardholder is married filing joint and has a working |
| | spouse that does not have a form W-5 on file, user |
| | is presented with Screen 10a (See FIG. 12) that |
| | explains that the advance EIC option may not be |
| | advisable for cardholder under these circumstances. |
| | User must then check the “yes” box to continue with |
| | this option. Checking the “no” box will deselect |
| | this option. |
| | If cardholder has more than one employer and has a |
| | W-5 form already in place with another employer” - |
| | user is presented with Screen 10b (see FIG. 13) that |
| | explains that cardholder can only have a W-5 in |
| | place with one employer that offers direct deposit |
| | pay. |
| | If cardholder does not meet all eligibility |
| | requirements then proceed to Step 200.1a15. |
| 200.1a14 | If all IRS and card program eligibility requirements |
| | are met, then provide responses to questions |
| | regarding cardholder's current federal and state |
| | withholding elections. See FIGS. 14 and 15, Screens |
| | 11 and 12, respectively. |
| | If cardholder does not meet all eligibility |
| | requirements, then Screen 14 is displayed (see FIG. |
| | 17). |
| 200.1a15 | Submit card setup request to card processor, print |
| | applicable card application for cardholder and save |
| | cardholder setup data in linked database of existing |
| | cardholders. If the advance EIC option was elected, |
| | then Screen 13 is displayed (see FIG. 16). |
| 200.1a16 | For those cardholders who elected the advance EIC |
| | option, batch process, print and mail (on a daily |
| | basis) the paperwork that these cardholders need to |
| | file with their employers. |

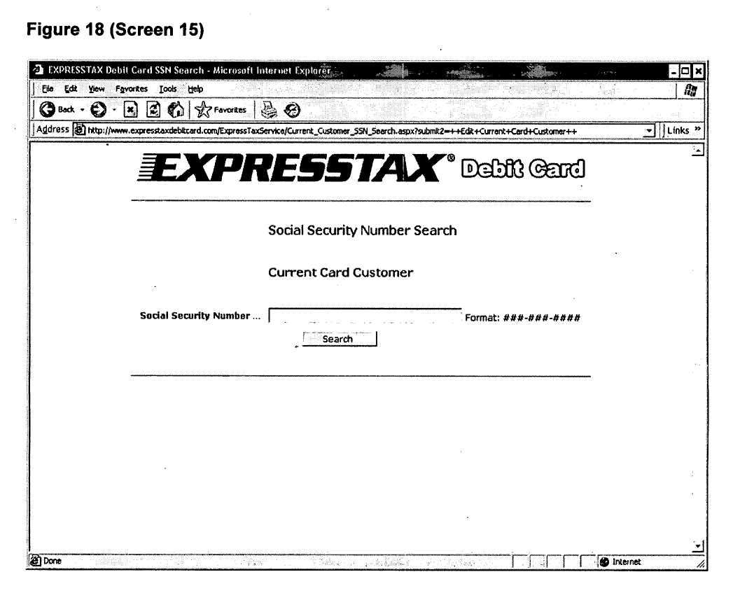

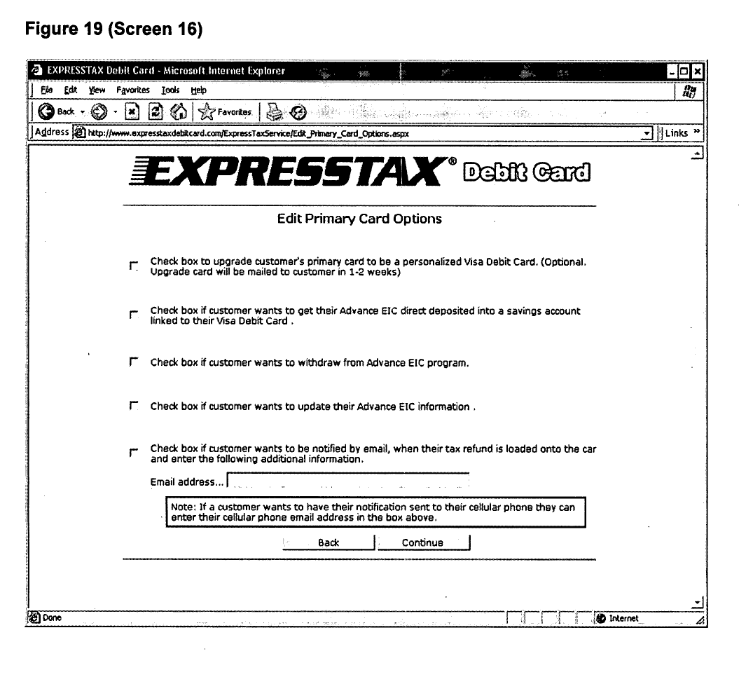

Card Option Editing Sub-Process 200.1b:

| Steps | Data Entry Result/Result |
|---|---|
| 200.1b1 | Enter tax preparer's (22) identifying information, |
| | including Electronic Filing Identification Number |
| | (EFIN), name, and login password. See FIG. 3, |
| | Screen 1. |
| | Proceed to Main Menu screen Step 200.1b2. |
| 200.1b2 | Select Main Menu option to “Edit Current Card |
| | Customer” See FIG. 4, Screen 2. |
| 200.1b3 | Enter taxpayer's (24) Social Security Number (SSN) |
| | See FIG. 18, Screen 15. |
| 200.1b4 | Perform search for taxpayer's (24) SSN in linked |
| | database of existing cardholders. |
| 200.1b5 | If match found in database of existing cardholders, |
| | then proceed to Step 200.1b6. Otherwise, if no match |
| | found, display error message and return to Step |
| | 200.1b3. |
| 200.1b6 | If Step 200.1b5 verifies a match found in database |
| | of existing cardholders, display Customer's Current |
| | Card Status Information (i.e., card number, date |
| | issued, etc.). See FIG. 7, Screen 5. |
| | Proceed to Step 200.1b7. |
| 200.1b7 | Select or change existing card setup options such as |
| | upgrading from non-personalized debit card to |
| | personalized debit card, and electing automatic |
| | split-out of advance EIC deposits into separate sub- |
| | account savings purse 35b associated with card 35a |
| | (i.e., advance EIC option). Also utilize this |
| | screen to report cardholder tax situation changes |
| | that affect their eligibility for advance EIC and/or |
| | changes to their federal and state withholding |
| | elections. See FIG. 19, Screen 16. |
| 200.1b8 | If option to add or change advance EIC is selected, |
| | proceed to Step 200.1b9. Otherwise, submit card |
| | option add/change request to card processor, print |
| | updated card application for cardholder (if |
| | applicable), and save cardholder setup |
| | additions/changes in linked database of existing |
| | cardholders. See FIG. 19, Screen 16. |
| 200.1b9 | Provide responses to questions regarding advance EIC |
| | eligibility requirements as set forth in IRS |
| | regulations. The questions verify that cardholder |
| | is able to utilize the card program's advance EIC |
| | option based on current program criteria (ex., state |
| | of residence for state withholding purposes, and |
| | verification that cardholder's employer offers the |
| | direct deposit pay option. See FIGS. 10 and 11, |
| | Screens 8 and 9, respectively. |
| | If cardholder does not meet all eligibility |
| | requirements, then proceed to Step 200.1b11. |
| 200.1b10 | If all IRS and card program eligibility requirements |
| | are met, then provide responses to questions |
| | regarding cardholder's current federal and state |
| | withholding elections. See FIGS. 14 and 15, Screens |
| | 11 and 12, respectively. |
| | If cardholder does not meet all eligibility |
| | requirements, then Screen 14 is displayed (see FIG. |
| | 17). |
| 200.1b11 | Submit card option add/change request to card |
| | processor, print applicable card application for |
| | cardholder, and save cardholder option add/change |
| | request data in linked database of existing |
| | cardholders. If the advance EIC option was elected, |
| | then Screen 13 is displayed (see FIG. 16). |
| 200.1b12 | For those cardholders who elected the advance EIC |
| | option, batch process, print and mail (on a daily |
| | basis) the paperwork that these cardholders need to |
| | file with their employers. |

Advance EIC Eligibility Sub-Process 200.1c:

Advance EIC eligibility sub-process 200.1c is preferably an associated process of, and otherwise integrated within, sub-processes 200.1a and 200.1b. More specifically, the eligibility questions of Step 200.1a13 of sub-process 200.1a, and Step 200.1b9 of sub-process 200.1b, and the steps resulting from the responses provided thereto, are preferably a function of sub-process 200.1c. Sub-process 200.1c is described hereinbelow.

| Steps | Data Entry Request/Result |
|---|---|
| 200.1c1 | Following verification of taxpayer's (24) |
| | election of the advance EIC option, proceed |
| | with question sets hereinbelow. |
| | (The designation “<year>” hereinbelow refers |
| | to the applicable tax year in which the |
| | advance EIC is being sought.) |
| | (The designation “<IRS code amount>” |
| | hereinbelow refers to the specific dollar |
| | amount codified in applicable IRS tax code |
| | based upon the filing status of taxpayer 24.) |
| 200.1c2 | First Question Set (eligibility): |
| | (1) Select taxpayer's expected <year> filing |
| | status: |
| | (a) Married filing separate (1) (If |
| | answer is “Married filing |
| | separate”, then taxpayer does not |
| | qualify for advance EIC direct |
| | deposit of system and method 10.) |
| | (b) Married filing joint (both |
| | work) (2) |
| | (c) Married filing joint (spouse does |
| | not work) (3) |
| | (d) Single/Qualifying Widow (4) |
| | (e) Head of household (5) |
| | (2) Select taxpayer's <year> pay frequency: |
| | (a) Weekly (1) |
| | (b) Bi-weekly (every two weeks) (4) |
| | (c) Semi-monthly (twice a month) (7) |
| | (d) Monthly (10) |
| | (e) Quarterly (4 times/year) (13) |
| | (f) Semi-annually (twice a year) (16) |
| | (g) Annually (19) |
| | (h) Daily or miscellaneous (22) (If |
| | answer is “Daily”, then taxpayer does |
| | not qualify for advance EIC direct |
| | deposit of system and method 10.) |
| | (3) Does taxpayer plan to file a federal |
| | income tax return for <year>? (If answer is |
| | “no”, then taxpayer does not qualify for |
| | advance EIC direct deposit of system and |
| | method 10.) |
| | (4) Does taxpayer have Social Security and |
| | Medicare withheld from their pay? (If answer |
| | is “no”, then taxpayer does not qualify for |
| | advance EIC direct deposit of system and |
| | method 10.) |
| | (5) Does taxpayer expect to have at least one |
| | qualifying child for <year>? (If answer is |
| | “no”, then taxpayer does not qualify for |
| | advance EIC direct deposit of system and |
| | method 10.) |
| | (6) If taxpayer expects to have only one (1) |
| | qualifying child for <year>, does taxpayer |
| | expect his earned income to be less than |
| | <applicable IRS code amount> (Less than |
| | <applicable IRS code amount> if married and |
| | filing joint, and including earned income of |
| | spouse)? (If answer is “no”, then taxpayer |
| | does not qualify for advance EIC direct |
| | deposit of system and method 10.) |
| | (7) If taxpayer expects to have two (2) |
| | qualifying children for <year>, does taxpayer |
| | expect his earned income to be less than |
| | <applicable IRS code amount> (Less than |
| | <applicable IRS code amount> if married and |
| | filing joint, and including earned income of |
| | spouse)? (If answer is 'no”, then taxpayer |
| | does not qualify for advance EIC direct |
| | deposit of system and method 10.) |
| | Assuming ineligibility of taxpayer (24) based |
| | on the answers to the above first question |
| | set, tax preparer (22) should notify taxpayer |
| | (24) of ineligibility, and return to screens |
| | of Step 200.1a11 of sub-process 200.1a for |
| | modification of card selection options and |
| | completion of the card application process- |
| | otherwise tax preparer (22) should proceed to |
| | Second Question Set of Step 200.1c3 |
| | hereinbelow. |
| 200.1c3 | Second Question Set (eligibility continued): |
| | (1) Select taxpayer's state of residence for |
| | withholding tax purposes. (must be a two-letter |
| | postal code from a provided list, wherein any |
| | State(s) not include within the list means |
| | that the present system 10is not provide in |
| | such State(s) and, thus, taxpayer may not |
| | participate in the advance EIC savings plan of |
| | the present invention.) |
| | (2) Does taxpayer's employer support the |
| | direct deposit pay option for employees with |
| | bank accounts? (If answer is “no”, then |
| | taxpayer does not qualify for advance EIC |
| | direct deposit of system and method 10.) |
| | (3) Does taxpayer currently have a form W-5 |
| | already in place with another employer? (If |
| | answer is “yes”, then the only way to qualify |
| | is for taxpayer to use that particular |
| | employer's direct deposit pay option, if |
| | available; otherwise, taxpayer will not |
| | qualify for advance EIC direct deposit of |
| | system and method 10.) |
| | (4) If married filing joint (both work), does |
| | taxpayer's spouse currently have a form w-5 in |
| | place with an employer? (If answer is “No”, |
| | then advise taxpayer that it may not be |
| | advisable to elect this option and prompt |
| | taxpayer to decide whether to continue with |
| | option selection.) |
| | (5) Does taxpayer expect to receive investment |
| | income (taxable or exempt interest, dividends, |
| | capital gains) of more than <IRS code amount> |
| | in <year>? (If answer is “yes”, then taxpayer |
| | does not qualify for advance EIC direct |
| | deposit of system and method 10.) |
| | (6) Is taxpayer (or taxpayer's spouse, if |
| | married filing joint) going to be claimed as |
| | the qualifying child on another person's |
| | <year> tax return? (If answer is “yes”, then |
| | taxpayer does not qualify for advance EIC |
| | direct deposit of system and method 10.) |
| | Assuming ineligibility of taxpayer (24) based |
| | on the answers to the above second question |
| | set, tax preparer (22) should notify taxpayer |
| | (24) of ineligibility, and return to screens |
| | of Steps 200.1a11 of sub-process 200.1a for |
| | modification of card selection options and |
| | completion of the card application process- |
| | otherwise tax preparer (22) should proceed to |
| | Third Question Set of Step 200.1c4 |
| | hereinbelow. |
| 200.1c4 | Third Question Set (enrollment): |
| | Congratulations, taxpayer (24) qualifies for |
| | direct deposit of advance EIC via system and |
| | method 10. Please have taxpayer (24) provide |
| | answers to the following questions: |
| | (1) Is taxpayer exempt from federal income tax |
| | withholding for <year>? Y/N |
| | If “No”, then answer the following |
| | questions: |
| | (a) Enter the number of federal |
| | withholding allowances taxpayer is |
| | claiming in <year> (i.e., must be |
| | whole number; Also, Check this box |
| | if taxpayer is legally separated or |
| | married to a non-resident alien) |
| | (b) If married, check box if taxpayer |
| | wishes to be taxed at higher single |
| | rate. |
| | (c) Enter the amount of additional |
| | federal taxes taxpayer has elected |
| | to have withheld from each <year> |
| | paycheck, if applicable. |
| | (d) Enter the amount of any <year> post- |
| | tax deductions (such as automatic |
| | charity contributions to a specific |
| | organization) taken out of each |
| | paycheck. |
| | (e) Enter the percentage or amount of |
| | gross pay deducted from each <year> |
| | paycheck on a pre-tax basis (such as |
| | 401(k) contributions), if any. |
| | (2) Is taxpayer exempt from state income tax |
| | withholding for <year>? Y/N |
| | If “No”, then answer the following |
| | questions: |
| | (a) Enter the number of state personal |
| | withholding allowances taxpayer |
| | (and, if applicable, taxpayer's |
| | spouse) is claiming in <year> (i.e., |
| | must be a whole number; cannot |
| | exceed 2 - next data field |
| | hereinbelow may be utilized to enter |
| | additional allowances). |
| | (b) Enter the number of additional |
| | personal withholding allowances |
| | taxpayer (and, if applicable, |
| | taxpayer's spouse) is claiming in |
| | <year> (i.e., must be a whole |
| | number). |
| | (c) Enter the number of state dependent |
| | withholding allowances taxpayer |
| | (and, if applicable, taxpayer's |
| | spouse) is claiming in <year> (i.e., |
| | must be a whole number). |
| | (d) Enter the amount of any additional |
| | state taxes taxpayer has elected to |
| | have withheld from each <year> |
| | paycheck. |
| 200.1c5 | Following Step 200.1c4, display the following |
| | message: |
| | A completed Form W-5 and W-4 will be mailed to |
| | the taxpayer around the same time as |
| | taxpayer's VISA debit card is mailed. Upon |
| | receipt of the foregoing forms and card, |
| | taxpayer should file the forms with his |
| | employer according to the directions provided. |
| | If taxpayer's tax situation changes, taxpayer |
| | may need to file a new Form W-5 and/or W-4. |
| | Taxpayer should notify you (the tax preparer) |
| | of the change as soon as possible so that you |
| | may assist the taxpayer in communicating the |
| | change to us (card program processor). If |
| | applicable, we will mail revised forms to the |
| | taxpayer to file with his employer. |
| 200.1c6 | Advance EIC Eligibility Sub-Process 200.1c is |
| | now complete. |
| | Return to screens of Step 200.1a15 of sub- |
| | process 200.1a for completion of card |
| | application process. |

It should be recognized that the various steps, duties and responsibilities of system and method 10 may be harmonized and implemented by one or more members and/or entities of the present invention. For instance, tax preparer 22 may in fact be taxpayer 24; program bank sponsor 35 may in fact be card program processor 30 and tax preparer 22; and, card program processor 30 may in fact be program bank sponsor 35 and tax preparer 22. Indeed, various iterations of the foregoing may be provided without limitation and without departing from the spirit of the present invention.

Having thus described exemplary embodiments of the present invention, it should be noted by those skilled in the art that the within disclosures are exemplary only, and that various other alternatives, adaptations, and modifications may be made within the scope of the present invention. Additionally, merely listing or numbering the steps of a method in a certain order does not constitute any limitation on the order of the steps of that method. Accordingly, the present invention is not limited to the specific embodiments illustrated herein, but is limited only by the following claims.

What is claimed is:

1. A method for financial management of a taxpayer's advance earned income credit, said method comprising the step of:
automatically extracting advance earned income credit directly from the taxpayer's net pay.

2. The method of claim 1, wherein said step comprises the step of utilizing an application software for automatically extracting advance earned income credit directly from the taxpayer's net pay.

3. The method of claim 1, comprising the prior step of direct depositing the taxpayer's net pay, advance earned income credit inclusive, onto a stored-value debit card.

4. The method of claim 3, wherein said step of automatically extracting advance earned income credit directly from the taxpayer's net pay comprises the step of extracting the advance earned income credit from the taxpayer's net pay direct deposited onto the stored-value debit card.

5. The method of claim 4, comprising the step of transferring the extracted advance earned income credit into a sub-account associated with the debit card.

6. The method of claim 5, further comprising the step of converting the debit card into a secured credit card with overdraft protection of up to a fixed percentage of at least a portion of total advance earned income credit accumulated within the sub-account.

7. The method of claim 5, further comprising the step of earning interest on at least a portion of total advance earned income credit accumulated within the sub-account.

8. The method of claim 5, further comprising the step of utilizing at least a portion of total advance earned income credit accumulated within the sub-account as collateral on against a loan.

9. The method of claim 5, further comprising the step of transferring at least a portion of total advance earned income credit accumulated within the sub-account to the debit card and, thereby, gaining access to emergency cash flow funds.

10. The method of claim 1, comprising the prior step of utilizing an application software to input the taxpayer's personal and tax-related data through a web portal.

11. The method of claim 10, further comprising the step of requesting, through the web portal, setup and issuance of a debit card and associated sub-account for direct deposit of the taxpayer's net pay, advance EIC inclusive, onto the debit card.

12. The method of claim 11, further comprising the step of issuing a debit card to the taxpayer, and establishing the associated sub-account.

13. The method of claim 12, further comprising the step of forwarding to the taxpayer's employer(s) IRS tax forms requesting advance earned income credit.

14. The method of claim 13, further comprising the step of calculating the taxpayer's net pay, and direct depositing the taxpayer's net pay, with advance earned income included therein, onto the taxpayer's debit card.

15. The method of claim 14, further comprising the step of referencing the taxpayer's previously entered personal and tax-related data, and tabulating total available advance earned income credit for implementation of said step of automatically extracting advance earned income credit from the taxpayer's net pay direct deposited on the debit card.

16. The method of claim 15, performing said step of automatically extracting advance earned income credit from the taxpayer's net pay direct deposited on the debit card, and, thereafter, transferring the extracted advance earned income credit into the sub-account associated with the debit card.

17. A system for financial management of a taxpayer's advance earned income credit, said system comprising:
a globally-networked computer system and an associated application software, wherein said computer system and said application software enable the taxpayer, or authorized representative, to access a web portal, and request through said web portal, automated extraction of the taxpayer's available advance earned income credit directly from the taxpayer's net pay.

18. The system of claim 17, further comprising a stored-value debit card onto which the taxpayer's net pay, advance earned income credit inclusive, is direct deposited, and from which the advance earned income credit is subsequently automatically extracted.

19. The system of claim 18, further comprising a sub-account into which at least a portion of extracted advance earned income credit is transferred.

20. A method for tabulating total advance earned income credit extractable from a taxpayer's net pay, said method comprising the steps of:
a. obtaining the taxpayer's total net pay amount, wherein the net pay amount includes the taxpayer's advance earned income credit (EIC); and,
b. reverse tabulating and grossing up the taxpayer's total net pay amount to determine total extractable advance EIC.

21. The method of claim 20, wherein said step b. comprises the prior step of determining the taxpayer's advance EIC status, and assigning an EIC code number thereto.

22. The method of claim 21, further comprising the step of determining the taxpayer's pay frequency, and assigning a pay frequency code number thereto.

23. The method of claim 22, further comprising the step of summing said EIC code number and said pay frequency code number to yield a row value number.

24. The method of claim 23, further comprising the step of referencing a table comprising sequentially numbered rows of federal withholding and EIC variables, and selecting federal withholding and EIC variables from a numbered row of said table, wherein said numbered row is equivalent in number to said row value number.

25. The method of claim 24, further comprising the step of extracting federal withholding and EIC variables from said numbered row and populating calculation variables.

26. The method of claim 20, comprising step c. of building an iteration of a dynamic wage table reflecting data values selected from the group consisting of average wages, advance EIC, federal tax amounts, Federal Insurance Contributions Act amounts, state tax amounts, net pay, and combinations thereof.

27. The method of claim 26, comprising step d. of adjusting the taxpayer's net pay amount for post-tax deductions and additional federal and state withholdings to yield an adjusted net pay amount.

28. The method of claim 27, comprising step e. of locating on said dynamic wage table a net pay data value that at least closely matches the adjusted net pay amount.

29. The method of claim 28, comprising step f. of locating on said dynamic wage table an average wage that corresponds to the adjusted net pay amount, and decreasing a corresponding wage increment by a multiple of ten.

30. The method of claim 29, comprising the step of repeating step c. through step f. by building various iterations of dynamic wage tables and decreasing wage increments by a multiple of ten until the wage increment drops to zero; thereby, providing total available advance EIC amount extractable from the taxpayer's net pay amount.
